(19) United States
(12) Patent Application Publication
(10) Pub. No.: US 2025/0082019 A1
(43) Pub. Date: Mar. 13, 2025

(54) CARTRIDGE AND AEROSOL GENERATING DEVICE INCLUDING THE SAME

(71) Applicant: KT&G CORPORATION, Daejeon (KR)

(72) Inventors: Sun Hwan JUNG, Daejeon (KR); Jong Sub LEE, Gyeonggi-do (KR); Byung Sung CHO, Gyeonggi-do (KR); Dae Nam HAN, Seoul (KR)

(73) Assignee: KT&G CORPORATION, Daejeon (KR)

(21) Appl. No.: 18/580,795

(22) PCT Filed: Oct. 12, 2023
(86) PCT No.: PCT/KR2023/015726

§ 371 Date: Jan. 19, 2024

(30) Foreign Application Priority Data
Nov. 23, 2022 (KR) 10-2022-0158442
Mar. 21, 2023 (KR) 10-2023-0036706

(51) Int. Cl. A24F 40/42; A24F 40/10; A24F 40/44; A24F 40/465; H05B 6/10; H05B 6/44

(52) U.S. Cl. CPC A24F 40/42; A24F 40/10; A24F 40/44; A24F 40/465; H05B 6/108; H05B 6/44

(57) ABSTRACT

A cartridge includes a storage unit configured to store an aerosol generating material, a wick arranged under the storage unit and configured to absorb the aerosol generating material supplied from the storage unit, and one or more susceptors arranged on at least one outer surface of the wick, and configured to atomize the aerosol generating material absorbed into the wick into an aerosol by generating heat in response to an induced magnetic field.

### TECHNICAL FIELD

Various embodiments relate to a cartridge and an aerosol generating device including the same, and more particularly, to a cartridge applying an induction heating method and an aerosol generating device including the same.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

One of various methods of heating an aerosol generating material is an induction heating method. The induction heating method refers to a method of generating heat from a magnetic body by applying an alternating magnetic field thereto. Here, the alternating magnetic field may be referred to as an induced magnetic field.

When the alternating magnetic field is applied to the magnetic body, energy loss due to an eddy current loss and a hysteresis loss may occur in the magnetic body. The energy that is lost may be emitted from the magnetic body as thermal energy. When an amplitude or frequency of the alternating magnetic field increases, a large amount of thermal energy may be emitted from the magnetic body.

### DISCLOSURE OF INVENTION

### Technical Problem

A liquid cartridge may generally have a structure in which a wick (e.g., cotton, silica, ceramic, or the like) for absorbing liquid is coupled to a heating clement for atomizing the liquid (e.g., a coil using a resistance heating principle). An existing liquid cartridge may directly heat a heating clement by receiving power through a contact terminal. During direct heating through the contact terminal, heat loss may occur at the contact terminal and a power supply line.

In addition, during direct heating through the contact terminal, both ends of the heating element need to be connected to the contact terminal. When a plurality of heating elements are arranged on various surfaces of a wick, many contact terminals corresponding to the number of heating elements are required, and thus, the internal structure of the cartridge may be complicated. Also, it is difficult to arrange many heating elements within a limited space inside the cartridge.

In addition, during direct heating through the contact terminal, all portions of the heating clement may not be uniformly heated, and thus, harmful materials may be generated due to carbonization of the wick at a portion at which a temperature is higher than a target temperature.

Embodiments provide a cartridge including a susceptor heated by an induced magnetic field generated by an induction coil of a main body of an aerosol generating device and an aerosol generating device including the cartridge.

In addition, the embodiments provide a cartridge including one or more susceptors that may be arranged on various surfaces of a wick and an aerosol generating device including the cartridge.

In addition, the embodiments provide a cartridge including a susceptor integrally formed with a wick, which is capable of performing both functions of the wick and the susceptor, and an aerosol generating device including the same.

The technical problems of the present disclosure are not limited to the above-described description, and other technical problems may be clearly understood by one of ordinary skill in the art from the embodiments to be described hereinafter.

### Solution to Problem

According to an aspect of the disclosure, a cartridge includes a storage unit configured to store an aerosol generating material, a wick arranged under the storage unit and configured to absorb the aerosol generating material supplied from the storage unit, and one or more susceptors arranged on at least one outer surface of the wick, and configured to atomize, into an aerosol, the aerosol generating material absorbed into the wick by generating heat in response to an induced magnetic field.

According to another aspect of the disclosure, a cartridge includes a storage unit configured to store an aerosol generating material, and a susceptor integrally formed with a wick, which is arranged under the storage unit and configured to absorb the aerosol generating material supplied from the storage unit and atomize the absorbed aerosol generating material absorbed from the storage unit into an aerosol by generating heat in response to an induced magnetic field.

According to another aspect of the disclosure, an aerosol generating device includes a cartridge, and a main body including an induction coil arranged under the cartridge to generate an induced magnetic field.

### Advantageous Effects of Invention

According to a cartridge and an aerosol generating device including the same according to embodiments, a separate contact terminal and a power supply line connecting the cartridge to a main body are not needed, and thus, heat loss may be reduced and heating efficiency may be improved.

In addition, according to the cartridge and the aerosol generating device including the same, according to the embodiments, the degree of freedom in an arrangement of a heating element (a susceptor) with respect to a wick may be improved, and the structure of the cartridge may be simplified.

In addition, according to the cartridge and the aerosol generating device including the same, according to the embodiments, harmfulness to a user may be reduced.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIGS. 1 to 3 are diagrams illustrating examples of an aerosol generating device.

FIG. 4A is a perspective view schematically illustrating an aerosol generating device according to an embodiment.

FIG. 4B is a perspective view illustrating that a cartridge of the aerosol generating device illustrated in FIG. 4A is decoupled from a main body.

FIG. 5 is a cross-sectional view taken in a direction V-V of the aerosol generating device illustrated in FIG. 4A.

FIGS. 6A and 6B are perspective views schematically illustrating various embodiments of a cartridge.

FIGS. 7A to 7C are views illustrating various shapes of an induction coil of an aerosol generating device, according to an embodiment.

FIG. 8 is a view illustrating a direction of magnetic force lines generated by an induction coil of an aerosol generating device, according to an embodiment.

FIG. 9 is a perspective view illustrating a wick and a susceptor arranged in a cartridge, according to an embodiment.

FIGS. 10A to 10C are top views of a wick on which a susceptor with evenly spaced apart patterns is arranged, according to embodiments.

FIGS. 11A and 11B are top views of a wick on which a susceptor with unevenly spaced apart patterns is arranged, according to embodiments.

FIGS. 12A and 12B are perspective views of a wick on which two susceptors are arranged on different outer surfaces, according to embodiments.

FIG. 13 is a perspective view of a cartridge including a hollow and a joint portion, according to an embodiment.

FIG. 14 is a perspective view illustrating a susceptor integrally formed with a wick, according to an embodiment.

FIG. 15 is a block diagram of an aerosol generating device according to an embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. In other words, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

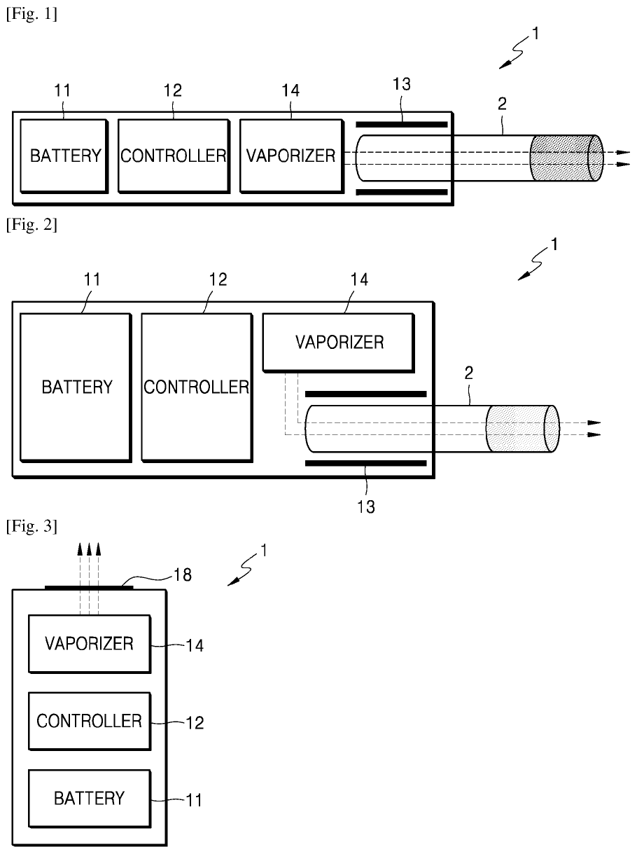

FIGS. 1 to 3 are diagrams illustrating examples of an aerosol generating device.

Referring to FIGS. 1 to 3, an aerosol generating device 1 may include a battery 11, a controller 12, a heater 13, and a vaporizer 14.

The aerosol generating device 1 of FIGS. 1 and 2 may include a housing including an accommodation space in which an aerosol generating article 2 is accommodated. The aerosol generating article 2 may be inserted into the aerosol generating device 1, and accordingly, the aerosol generating article 2 may be accommodated in the accommodation space of the housing. In addition, FIGS. 1 and 2 illustrate that the aerosol generating device 1 includes the heater 13, but the heater 13 may be omitted as needed.

The aerosol generating device 1 of FIG. 3 may not include a space into which the aerosol generating article 2 may be inserted, and accordingly, the heater 13 for heating the aerosol generating article 2 may not be arranged.

The aerosol generating device 1 illustrated in FIGS. 1 to 3 may include only components related to the present embodiment. Accordingly, the aerosol generating device 1 may further include other components, in addition to the components illustrated in FIGS. 1 to 3.

FIG. 1 illustrates that the battery 11, the controller 12, the vaporizer 14, and the heater 13 are arranged in a line. In addition, as illustrated in FIG. 2, the vaporizer 14 and the heater 13 may be arranged in parallel. However, the internal structure of the aerosol generating device 1 is not limited to those illustrated in FIGS. 1 to 3. In other words, the arrangement of the battery 11, the controller 12, the vaporizer 14, and the heater 13 may be changed according to the design of the aerosol generating device 1.

The battery 11 may supply power used to operate the aerosol generating device 1. For example, the battery 11 may supply power so that the heater 13 or the vaporizer 14 may be heated, and may supply power needed for the controller 12 to operate. In addition, the battery 11 may supply power needed for a display, a sensor, a motor, and the like installed in the aerosol generating device 1 to operate.

The controller 12 may control overall operation of the aerosol generating device 1. In detail, the controller 12 may control operations of the battery 11, the heater 13, and the vaporizer 14, as well as operations of the other components included in the aerosol generating device 1. In addition, the controller 12 may determine whether or not the aerosol generating device 1 is in an operable state, by identifying a state of each of the components of the aerosol generating device 1.

The controller 12 may include at least one processor. The processor may be implemented as an array of a plurality of logical gates, or a combination of a general-purpose microprocessor and a memory that stores programs that may be executed by the microprocessor. In addition, it may be understood by one of ordinary skill in the art to which the present embodiment belongs that the processor may be implemented as other types of hardware.

The heater 13 may be heated by power supplied from the battery 11. For example, when the aerosol generating article 2 is inserted into the aerosol generating device 1, the heater 13 may be located outside the aerosol generating article 2. Accordingly, the heated heater 13 may increase a temperature of an aerosol generating material within the aerosol generating article 2.

The heater 13 may be an electrically resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating an aerosol generating article in an induction heating method, and the aerosol generating article may include a susceptor which may be heated by the induction heater.

FIGS. 1 and 2 illustrate that the heater 13 is arranged outside the aerosol generating article 2, but the heater 13 is not limited thereto. For example, the heater 13 may include a tube-type heating element, a plate-type heating element, a needle-type heating element, or a rod-type heating element, and may heat the inside or the outside of the aerosol generating article 2, according to the shape of the heating element.

Also, the aerosol generating device 1 may include a plurality of heaters 130. Here, the plurality of heaters 130 may be inserted into the aerosol generating article 2 or may be arranged outside the aerosol generating article 2. Also, some of the plurality of heaters 130 may be inserted into the aerosol generating article 2 and the others may be arranged outside the aerosol generating article 2. In addition, the shape of the heater 13 is not limited to the shapes illustrated in FIGS. 1 through 3 and may include various shapes.

The vaporizer 14 may be a component that stores an aerosol generating material, and generates a vaporized aerosol by heating the aerosol generating material.

The vaporizer 14 may include a liquid storage, a liquid delivery element, and a heating element, but is not limited thereto. For example, the liquid storage, the liquid delivery element, and the heating element may be included in the aerosol generating device 1 as independent modules.

The liquid storage may store the aerosol generating material. For example, the aerosol generating material may be a liquid including a tobacco-containing material having a volatile tobacco flavor component, or a liquid including a non-tobacco material. The liquid storage may be formed to be detachable from/attached to the vaporizer 14 or may be formed integrally with the vaporizer 14.

For example, the aerosol generating material may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the aerosol generating material may include an aerosol forming substance, such as glycerin and propylene glycol.

The liquid delivery element may deliver the aerosol generating material in the liquid storage to the heating element. For example, the liquid delivery element may be a wick such as cotton fiber, ceramic fiber, glass fiber, or porous ceramic, but is not limited thereto.

The heating element may be an element for heating the aerosol generating material delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery clement. The heating element may be heated by a current supply and may heat the aerosol generating material by transferring heat to the aerosol generating material in contact with the heating element. As a result, an aerosol may be generated from the aerosol generating material.

The generated aerosol may move along an air flow passage. As illustrated in FIGS. 1 and 2, the aerosol moved along the air flow passage may be delivered to the user by passing through the aerosol generating article 2. As illustrated in FIG. 3, the aerosol moved along the air flow passage may be delivered to the user through a mouthpiece 18.

The vaporizer 14 may be referred to as a cartomizer or an atomizer, but is not limited thereto.

According to an embodiment, the vaporizer 14 may be a cartridge that may be inserted into and detached from a main body of the aerosol generating device 1, or the aerosol generating device 1. When the aerosol generating material stored is all consumed, the vaporizer 14 may be replenished with an aerosol generating material or may be replaced with another vaporizer 14 that stores an aerosol generating material.

Hereinafter, a component corresponding to the vaporizer 14 may be referred to as a cartridge, and a cartridge and an aerosol generating device including the same, according to an embodiment, is described below in detail.

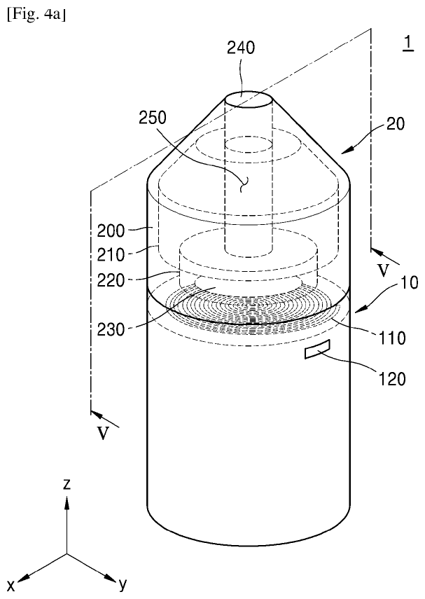

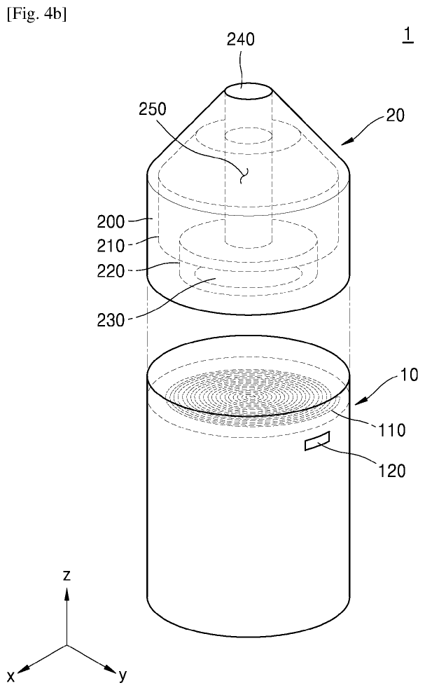

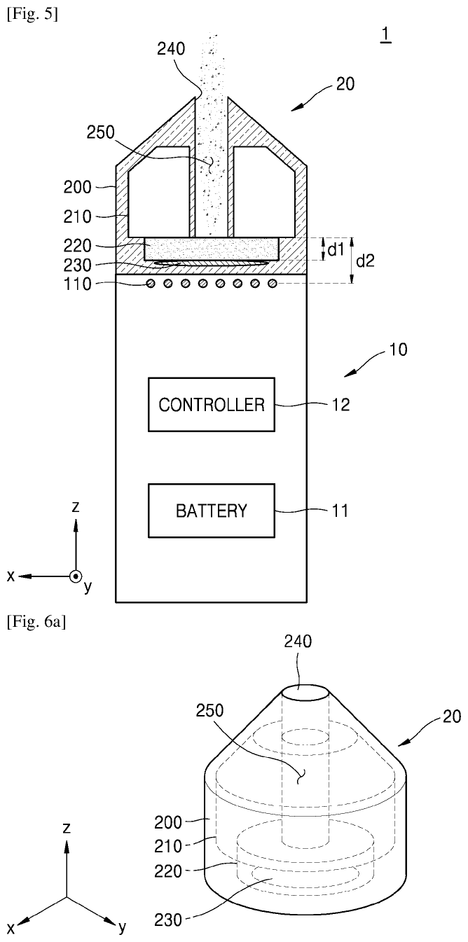

FIGS. 4A to 5 are views illustrating a cartridge and an aerosol generating device including the same, according to an embodiment.

FIG. 4A is a perspective view schematically illustrating an aerosol generating device according to an embodiment. FIG. 4B is a perspective view illustrating that a cartridge of the aerosol generating device illustrated in FIG. 4A is decoupled from a main body. FIG. 5 is a cross-sectional view taken in a direction V-V of the aerosol generating device illustrated in FIG. 4A.

Referring to FIGS. 4A to 5, an aerosol generating device 1 according to an embodiment may include a main body 10 and a cartridge 20.

At least one of components of the aerosol generating device 1 according to an embodiment may be the same as or similar to at least one of the components of the aerosol generating device 1 illustrated in FIGS. 1 to 3, and the same descriptions are omitted below.

The main body 10 may form a portion of the external appearance of the aerosol generating device 1 and may perform a function of accommodating and protecting the components of the aerosol generating device 1. For example, a battery 11 and a controller 12 may be accommodated inside the main body 10, but are not limited thereto.

The main body 10 may be manufactured in various shapes such as a cylindrical shape, an elliptical pillar shape, or a rectangular parallelepiped shape, but is not limited to the embodiment.

The cartridge 20 may be detachably coupled to one end of the main body 10 to form the external appearance of the aerosol generating device I together with the main body 10. The cartridge 20 may be coupled to the main body 10 to be applied as a component of the aerosol generating device 1. A mouthpiece 240 through which an aerosol may be inhale may be arranged in an upper portion of the cartridge 20.

The cartridge 20 may be coupled to the main body 10 while accommodating an aerosol generating material therein. For example, when a portion of the cartridge 20 is inserted into the main body 10, or a portion of the main body 10 is inserted into the cartridge 20, the cartridge 20 may be mounted on the main body 10. Here, the main body 10 and the cartridge 20 may be maintained coupled to each other by a snap-fit method, a screw coupling method, a magnetic coupling method, an interference fit method, or the like. However, the coupling method between the main body 10 and the cartridge 20 is not limited by the above description.

Referring to FIG. 4B, the cartridge 20 may be aligned with the main body 10 along the z-axis. When locations of the cartridge 20 and the main body 10 are aligned with each other, the cartridge 20 may be coupled to the body 10 by approaching in the −z direction. The cartridge 20 may be decoupled from the main body 10 in the +z direction. When the cartridge 20 is decoupled from the main body 10, components of the main body 10 may be exposed to the outside.

In general, a cartridge includes a heating element electrically operated to atomize an aerosol generating material. Here, the heating element may be the heating element included in the vaporizer 14 described above with reference to FIGS. 1 to 3.

When the cartridge is coupled to a main body, the heating element may be electrically connected to the main body to receive power from a battery through a contact terminal, and the power supply to the heating element may be controlled by a controller. In other words, when power is supplied to the heating element the power supply to the heating element is controlled, the heating element may be electrically directly heated.

In a method of electrically directly heating the heating element through the contact terminal (hereinafter, referred to as a wired heating method), heat loss inevitably occurs at the contact terminal and a power supply line.

In addition, in the wired heating method, all portions of the heating element may be uniformly heated. A portion of the heating element may have a temperature that is higher than a target temperature, and another portion may have a temperature that is lower than the target temperature. Here, the portion having the higher temperature than the target temperature may carbonize a wick.

Carbonization may refer to turning black due to high temperature heat. A harmful material may be generated during the carbonization of the wick, and the harmful material may be mixed with aerosols and introduced into the mouth of a user.

The aerosol generating device 1 according to an embodiment may generate an aerosol by heating the heating element in an induction heating method, to solve the heat loss and harmfulness issues described above. The induction heating method may refer to a wireless heating method in which only a heating body including a susceptor generates heat in response to an induced magnetic field.

The induction heating method may be the wireless heating method, and thus, heat loss may be reduced compared to heat loss of the wired heating method. Therefore, heating efficiency may be improved, and accordingly power consumption may be reduced.

In addition, a contact terminal and a power supply line are not required, and thus, the induction heating method may reduce heat generation by an aerosol generating device compared to the wired heating method.

In addition, the induction heating method may prevent a change in contact resistance occurring due to frequent attachment and detachment of the cartridge to and from the main body. Also, the degree of freedom in design of the external appearance of the cartridge is improved by the simple structure of the cartridge.

The induction heating method may heat the susceptor relatively uniformly, and thus, a temperature of the susceptor may be relatively uniform in all portions of the susceptor when compared to the wired heating method. In other words, the induction heating method may prevent some portions of the susceptor from being heated above the target temperature, and accordingly may alleviate the occurrence of the harmful material due to the carbonization of the wick.

The aerosol generating device 1 to which the induction heating method is applied may include an induction coil 110 for generating an induced magnetic field and a susceptor 230 heated by the induced magnetic field.

An arrangement of an induction coil and a susceptor may significantly affect atomization of an aerosol generating material stored inside a cartridge in an induction heating method. According to an embodiment, both the induction coil and the susceptor may be arranged in the cartridge as components of the cartridge. As another example, the induction coil may be arranged in a main body as a component of the main body, and the susceptor may be arranged in the cartridge as a component of the cartridge.

In the description below, it is assumed that the induction coil 110 is a component of the main body 10 arranged in the main body 10, and the susceptor 230 is a component of the cartridge 20 arranged in the cartridge 20.

The main body 10 may include the induction coil 110 for generating an induced magnetic field. The induction coil 110 may be arranged under the cartridge 20 and may generate the induced magnetic field toward the susceptor 230 arranged inside the cartridge 20.

The induction coil 110 may be supplied with power from the battery 11. When power is supplied to the induction coil 110, a magnetic field may be formed toward a lower portion of the cartridge 20.

When an alternating current is applied to the induction coil 110, a direction of the magnetic field formed toward the lower portion of the cartridge 20 may be periodically changed. When the susceptor 230 is exposed to the magnetic field formed by the induction coil 110, the susceptor 230 may generate heat. When the susceptor 230 generates heat, an aerosol generating material may be heated.

When an amplitude or frequency of the magnetic field formed by the induction coil 110 changes, a temperature of the susceptor 230 may change. The controller 12 may adjust the amplitude or frequency of the alternating magnetic field formed by the induction coil 110 by controlling the power supplied to the induction coil 110, and accordingly, and may control the temperature of the susceptor 230.

The induction coil 110 may include copper, but is not limited thereto. The induction coil 110 may include any one of silver (Ag), gold (Au), aluminum (Al), tungsten (W), zinc (Zn), and nickel (Ni), or an alloy including at least one thereof, so that the induction coil 110 allows a high current to flow therethrough by having low specific resistance.

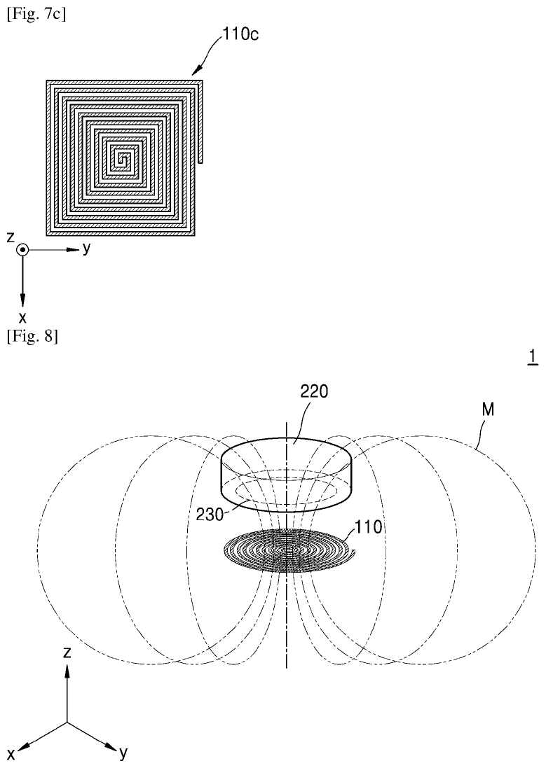

The induction coil 110 may include a spiral plate shape arranged to cross a longitudinal direction of the main body 10. Here, the longitudinal direction of the main body 10 may refer to the z-axis direction, which is a lengthwise direction of the cartridge 20. The spiral plate shape of the induction coil 110 and a direction of magnetic force lines are described below with reference to FIGS. 7A to 8.

In relation to a resonance phenomenon and efficiency of induction heating, when the frequency of the power supplied to the induction coil 110 becomes closer to a resonant frequency of the susceptor 230, the efficiency of induction heating may increase. The resonant frequency of the susceptor 230 may be determined by various factors. When a plurality of susceptors 230 are arranged, resonant frequencies thereof may be different from one another.

When one induction coil 110 is arranged, a plurality of susceptors 230 induction heated by the one induction coil 110 may have different heating efficiency. Therefore, one or more induction coils 110 may be arranged in accordance with the number of susceptors 230 to ensure high heating efficiency of the susceptors 230. In this case, power may be individually supplied to each induction coil 110 so that each induction coil 110 may have a frequency close to the resonant frequency of the corresponding susceptor 230.

The main body 10 may include an air inlet 120 in at least one area of a side surface thereof. Air from the outside of the aerosol generating device 1 may be introduced into the main body 10 through the air inlet 120, and the introduced air may pass through the inside of the aerosol generating device 1 and be mixed with an aerosol inside the cartridge 20. The aerosol may be then provided to the user through the mouthpiece 240 by passing through the inside of the cartridge 20.

The cartridge 20 according to an embodiment may include a case 200, a storage unit 210, a wick 220, the susceptor 230, the mouthpiece 240, and an air flow path 250.

Here, the storage unit 210 and the wick 220 may be the same as the liquid storage and the liquid delivery element, respectively, included in the vaporizer 14 described above with reference to FIGS. 1 to 3. The mouthpiece 240 may be the same as the mouthpiece 18 of FIG. 3.

The case 200 may form the external appearance of the cartridge 20, and may perform a function of accommodating and protecting the components of the cartridge 20. The storage unit 210, the wick 220, the susceptor 230, and the like may be accommodated in the case 200, but the disclosure is not limited thereto.

The case 200 may have a shape corresponding to a shape of the main body 10. For example, when the main body 10 has a cylindrical shape, at least a portion of the case 200 may have a cylindrical shape corresponding thereto. However, the shapes of the main body 10 and the case 200 are not limited to the embodiment.

The case 200 may include a structure that may be detachably coupled to one end of the main body 10 and a structure for maintaining the coupled state between the main body 10 and the cartridge 20.

The storage unit 210 may store an aerosol generating material in a liquid state or an aerosol generating material in a gel state.

The storage unit 210 may be manufactured in various shapes such as a cylindrical shape, an elliptical pillar shape, or a rectangular parallelepiped shape. According to an embodiment, the storage unit 210 may have a tubular shape including a hollow surrounded by an inner wall and having an outer wall of which at least portion narrows toward an upper portion of the storage unit 210. An aerosol generating material may be stored in an empty space surrounded by the outer wall and the inner wall of the storage unit 210.

The storage unit 210 may include at least one opening (not shown) through which the storage unit 210 is connected to the wick 220. The opening may be arranged in a lower portion of the storage unit 210. According to an embodiment, the wick 220 may be arranged at the opening, and may be in contact with the aerosol generating material flowing out of the storage unit 210 through the opening.

However, an arrangement relationship between the opening and the wick 220 is not limited to the embodiment. As another example, the wick 220 may be inserted into the storage 210 through the opening and be in contact with the aerosol generating material stored inside the storage unit 210.

The gap between the opening of the storage unit 210 and the wick 220 may be sealed and prevent the aerosol generating material from leaking. In other words, the storage unit 210 may be sealed to prevent the aerosol generating material from leaking to the outside of the storage unit 210 except through the wick 220.

The wick 220 may be arranged under the storage unit 210 and may absorb the aerosol generating material by receiving the aerosol generating material supplied from the storage unit 210.

The wick 220 may have various shapes. As an example, the wick 220 may have an elongated shape. As another example, the wick 220 may have a pillar shape extending in one direction. In detail, the wick 220 may have a polygonal pillar shape such as a cylindrical shape, a rectangular pillar shape, or a triangular pillar shape, but is not limited to the example mentioned above, and the wick 220 may have an approximately rod-type or needle-type shape.

At least a portion of the wick 220 may absorb the aerosol generating material supplied from the storage unit 210. For example, the aerosol generating material absorbed into one portion of the wick 220 may move to another portion of the wick 220 according to capillary action.

According to an embodiment, the wick 220 may absorb the aerosol generating material, which is supplied from the storage unit 210, through one end portion (e.g., an upper end portion) thereof, and the absorbed aerosol generating material may move to the other end portion (e.g., a lower end portion) of the wick 220.

The wick 220 may include porous ceramic. However, the material of the wick 220 is not limited to the embodiment, and may include all types of porous materials for transferring an aerosol generating material.

The susceptor 230 may atomize, into an aerosol, the aerosol generating material heated by an induced magnetic field and absorbed into the wick 220.

The susceptor 230 may include ferrite-based stainless steel. However, the material of the susceptor 230 is not limited to the embodiment, and may include all types of metal bodies having magnetism capable of induction heating.

The susceptor 230 may be arranged adjacent to the wick 220. According to an embodiment, the susceptor 230 may be arranged on a lower portion of the wick 220. Here, the susceptor 230 may contact a lower surface of the wick 220 and heat the aerosol generating material absorbed into the wick 220.

The susceptor 230 may be coupled to the wick 220. Here, coupling may refer to all methods of permanently or reversibly attaching the susceptor 230 to the wick 220, such as application, spraying, deposition, plating, dipping, painting, printing, 3D printing, and use of equipment, while the wick 220 is already manufactured, and all methods such as sintering the susceptor 230 together in a process of manufacturing the wick 220. Hereinafter, when the susceptor 230 is “arranged” on the wick 220, it may refer to cases in which the susceptor 230 is coupled to, in simple contact with, or in no contact with the wick 220.

When the main body 10 and the cartridge 20 are coupled to each other, the susceptor 230 may be arranged above the induction coil 110. Here, the susceptor 230 may be physically separated from the induction coil 110 by the case 200.

Referring to FIG. 5, a distance d1 from a lower portion of the storage unit 210 to the susceptor 230 may be smaller than a distance d2 from the lower portion of the storage unit 210 to the induction coil 110. In other words, the susceptor 230 may be spaced apart from the induction coil 110 by a distance obtained by subtracting the distance d1 from the distance d2.

The mouthpiece 240 may be arranged in an upper portion of the cartridge 20 and may be in contact with the mouth of the user. The mouthpiece 240 may be formed to protrude from the cartridge 20 in the +z direction. The mouthpiece 240 may have a shape that may easily contact the mouth of the user. The user may inhale the aerosol after bringing the mouthpiece 240 formed in the cartridge 20 into contact with the mouth.

The air flow path 250 may operate as a passage through which the atomized aerosol is delivered to the user. That is, the airflow path 250 may refer to a movement path inside the cartridge 20 through which the aerosol atomized by the susceptor 230 of the cartridge 20 moves to the mouthpiece 240.

External air may flow into the main body 10 through the air inlet 120, move along an air inflow path (not shown) formed in the main body 10, reach the inside of the cartridge 20, and mix with the aerosol. The aerosol, mixed with air, may move along the air flow path 250 and may be provided to the user through the mouthpiece 240.

A portion of the air flow path 250 may be arranged adjacent to the wick 220 and the susceptor 230, and the other portion of the air flow path 250 may be arranged adjacent to the mouthpiece 240. In other words, the air flow path 250 may bring the mouthpiece 240 into fluid communication with a space in which the wick 220 and the susceptor 230 are arranged.

According to an embodiment, the air flow path 250 may be formed along a tube surrounded by the inner wall of the storage unit 210, extending from the wick 220 and the susceptor 230 to the mouthpiece 240. However, the arrangement of the air flow path 250 is not limited to the embodiment. As another example, an air flow path may be formed along the outside of a storage unit.

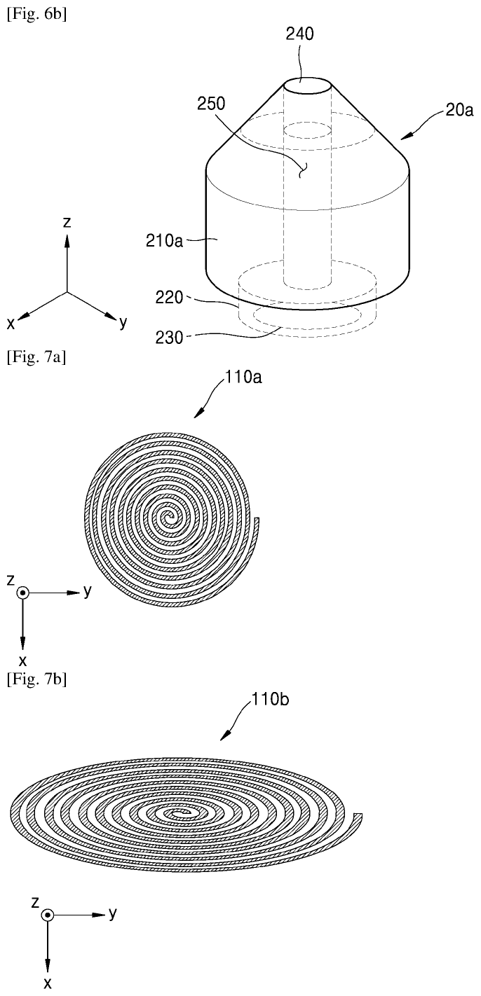

FIGS. 6A and 6B are perspective views schematically illustrating various embodiments of a cartridge.

At least one of components of a cartridge 20 illustrated in FIG. 6A and a cartridge 20a illustrated in FIG. 6B may be the same as or similar to at least one of the components of the cartridge 20 illustrated in FIGS. 4A and 4B, and the same description thereof is omitted.

Referring to FIG. 6A, the cartridge 20 illustrated in FIG. 6A may be the same as the cartridge 20 illustrated in FIG. 4A, according to an embodiment.

Referring to FIG. 6B, the cartridge 20a illustrated in FIG. 6B may differ from the cartridge 20 illustrated in FIG. 6A in that a case 200 is not present. The cartridge 20a may include a storage unit 210a, a wick 220, a susceptor 230, a mouthpiece 240, and an air flow path 250.

The cartridge 20a may not include the case 200, and an outer wall of the storage unit 210a may partially perform a function of the case 200.

As shown in FIG. 6B, the wick 220 may protrude from a lower portion of the storage unit 210a. Accordingly, the wick 220 and the susceptor 230 may be exposed to the outside of the cartridge 20a.

When the main body 10 and the cartridge 20a are coupled to each other, the induction coil 110 and the susceptor 230 may be arranged in one space, rather than in physically separated spaces. However, even in this case, the susceptor 230 may be spaced apart from the induction coil 110 without contacting the induction coil 110.

FIGS. 7A to 8 are views illustrating directions of an induction coil having a spiral plate shape and magnetic force lines.

FIGS. 7A to 7C are views illustrating various shapes of an induction coil of an aerosol generating device, according to an embodiment. FIG. 8 is a view illustrating a direction of magnetic force lines generated by an induction coil of an aerosol generating device, according to an embodiment.

Referring to FIGS. 7A to 7C, an aerosol generating device (e.g., the aerosol generating device 1 of FIG. 4A) according to an embodiment may include induction coils 110a, 110b, and 110c having various shapes.

The induction coil 110 arranged inside the main body 10 may be implemented in various shapes such as a spiral shape, a rectangular shape, or a pan-cake-shaped circular coil. The number of turns and shape of the induction coil 110 may be changed according to an induction heating resonant frequency, and external designs of a cartridge and a main body.

The induction coils 110a, 110b, and 110c illustrated in FIGS. 7A to 7C, respectively, may commonly have a spiral plate shape. Referring to FIG. 8, an induction coil 110 having a spiral plate shape may form a magnetic field in which magnetic force lines M enter and exit around a spiral axis of the induction coil 110 according to a direction of a current.

A susceptor 230 may be arranged in the same direction as the induction coil 110 having the spiral plate shape. Here, the same direction may indicate that the susceptor 230 is arranged in parallel with the induction coil 110 having the spiral plate shape.

As an example, the induction coil 110 and the susceptor 230 may be arranged in the same direction across a longitudinal direction of a main body (e.g., the main body 10 of FIG. 4A). In detail, the induction coil 110 and the susceptor 230 may be arranged in parallel to a direction in which a lower surface of a storage unit (e.g., the storage unit 210 of FIG. 4A) extends. However, the embodiment is not limited to the arrangement of an induction coil and a susceptor. As another example, the induction coil and the susceptor may be arranged in a direction parallel to a longitudinal direction of a main body.

According to an embodiment, the magnetic force lines M may enter and exit in the longitudinal direction of the main body 10 with respect to the wick 220 and the susceptor 230 arranged in parallel with the lower surface of the storage unit. In other words, the magnetic force lines M may pass, in a z-axis direction, through the wick 220 and the susceptor 230 arranged parallel to a xy plane.

Here, the susceptor 230 may be arranged so that a center of the susceptor 230 is at a location corresponding to a center of the spiral axis of the induction coil 110 along the longitudinal direction of the main body. For example, the center of the susceptor 230 may be aligned with the center of the spiral axis of the induction coil 110 in the z-axis direction. Accordingly, a density of the magnetic force lines M, which enter and exit the susceptor 230, may increase.

Unlike an induction coil included in an existing induction heating-type aerosol generating device, according an embodiment, the direction of the magnetic force lines M may be a direction crossing (e.g., perpendicular to) a direction in which the susceptor 230 extends, and thus the density of the magnetic force lines M passing through the susceptor 230 may increase, and accordingly heating efficiency of the susceptor 230 may be improved.

In particular, when the susceptor 230 has a flat sheet shape, the magnetic force lines M may pass through a large area of the sheet shape, and thus the susceptor 230 may be heated sufficiently.

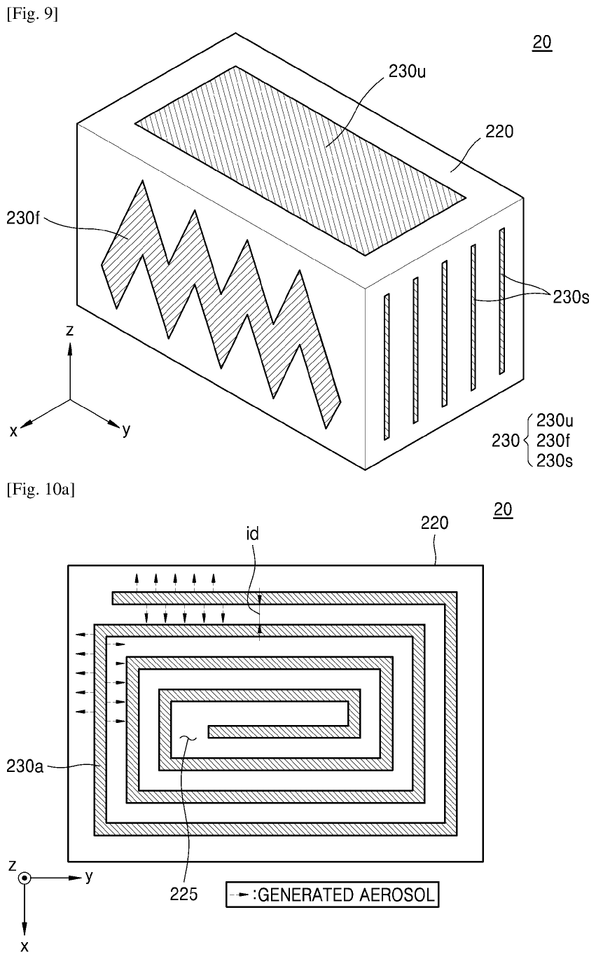

FIG. 9 is a perspective view illustrating a wick and a susceptor, which are arranged in a cartridge, according to an embodiment.

Referring to FIG. 9, a cartridge 20 according to an embodiment may include a wick 220 and one or more susceptors 230.

At least one of components of the cartridge 20 illustrated in FIG. 9 may be the same as or similar to at least one of the components of the cartridge 20 illustrated in FIG. 4A, and the same description thereof is omitted.

Unlike the wick 220 having the cylindrical shape, illustrated in FIG. 4A, the wick 220 illustrated in FIG. 9 may have a rectangular parallelepiped shape. However, the embodiment is not limited to a shape of a wick.

According to an embodiment, the one or more susceptors 230 may be arranged on the wick 220. In an existing wired heating method, both ends of a heating element need to be connected to a contact terminal. Therefore, when a plurality of heating elements are arranged on several surfaces of a wick, the number of contact terminals corresponding to the number of heating elements may be needed. Accordingly, the internal structure of a cartridge may be complicated, and thus, a plurality of heating elements may not be easily implemented in a limited space inside the cartridge.

According to induction heating of a wireless heating method, a contact terminal and a power supply line for the susceptor 230 are not required. Thus, the arrangement of the susceptor 230 may not be greatly affected by the limitation of a space inside the cartridge 20. In other words, a plurality of susceptors 230 may be arranged on the wick 220. According to the induction heating method, the degree of freedom in the arrangement of the susceptor 230 with respect to the wick 220 may be improved, and an internal structure of the cartridge 20 may be simplified.

The one or more susceptors 230 may be arranged inside and/or on an outer surface of the wick 220. As an example, the susceptor 230 may be inserted into a groove (not shown) formed in a first outer surface of the wick 220. Here, the susceptor 230 inserted into the groove may be coplanar with a remaining portion of the first outer surface of the wick 220 in which a groove is not formed. Accordingly, the first outer surface of the wick may be flat and smooth in the entire area without a protruding portion.

When the susceptor 230 is arranged inside the wick 220, an aerosol may be generated inside the wick 220 and thus the aerosol needs to travel through the inside of the wick 220 and flow out of the wick 220. In this regard, in terms of generation and movement of an aerosol, it may be more efficient when the susceptor 230 is arranged on an outer surface of the wick 220. Hereinafter, an example in which the susceptor 230 is arranged on the outer surface of the wick 220 is mainly described below.

The wick 220 may include a plurality of outer surfaces. FIG. 9 illustrates a front surface, a top surface, and a side surface from among outer surfaces of the wick 220. The susceptors 230 may be arranged on a plurality of outer surfaces of the wick 220, respectively.

Referring to FIG. 9, a susceptor 230u having a rectangular plate shape may be arranged on a top surface of the wick 220 (e.g., an outer surface facing a z-axis direction). A susceptor 230f having a zigzag pattern may be arranged on a front surface of the wick 220 (e.g., an outer surface facing an x-axis direction). A susceptor 230s having a straight pattern may be arranged on a side surface of the wick 220 (e.g., an outer surface facing a y-axis direction). However, the embodiment is not limited to the above-described patterns and shapes of the susceptor 230, and the susceptor 230 may have various patterns and shapes corresponding to a shape of an induction coil.

A plurality of susceptors 230 may be arranged on the outer surface of the wick 220. In other words, a plurality of susceptors 230 may be arranged on a plurality of outer surfaces of the wick 220, respectively, or a plurality of susceptors 230 may be arranged on the same outer surface of the wick 220. As an example, a plurality of susceptors 230s having a straight pattern may be arranged in parallel on a side surface of the wick 220.

According to an embodiment, one or more susceptors 230 may be arranged on at least one outer surface of the wick 220, and thus, a contact area and heating area of the susceptors 230 with respect to the wick 220 may increase. Therefore, heating efficiency may be improved and ultimately atomization performance may be improved.

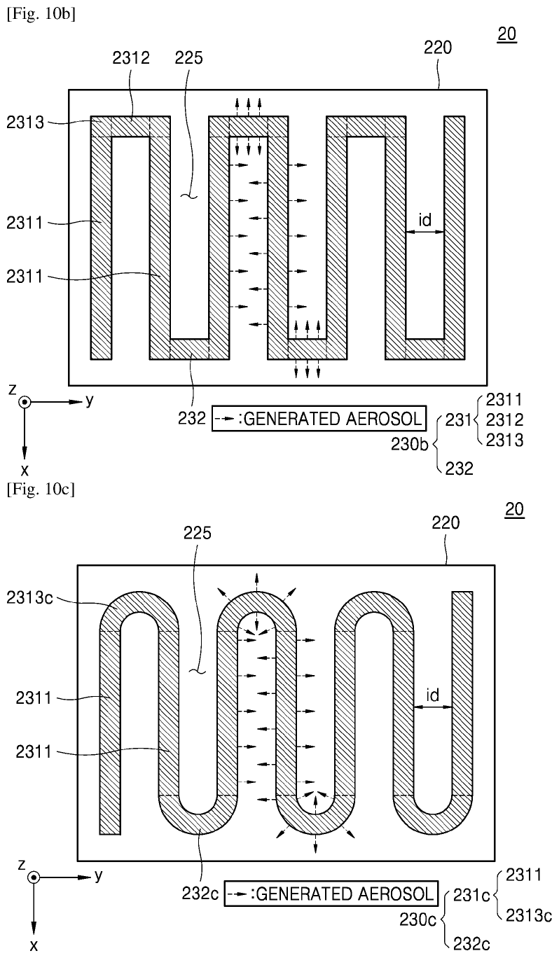

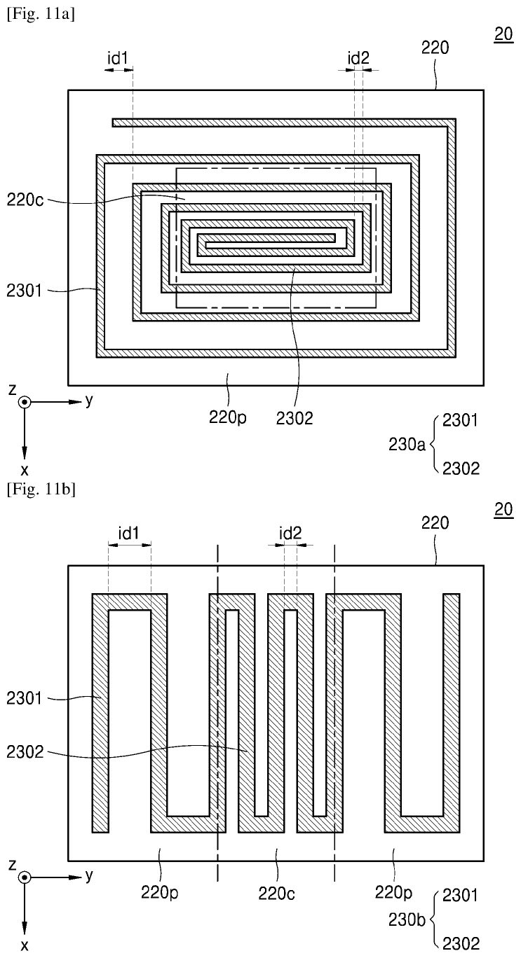

Hereinafter, various patterns of a susceptor for improving atomization performance are described below with reference to FIGS. 10A to 10C.

FIGS. 10A to 10C are top views of a wick on which a susceptor with evenly spaced apart patterns is arranged, according to embodiments.

Referring to FIGS. 10A to 10C, a cartridge 20 according to the respective embodiments may include a wick 220 and susceptors 230a, 230b, and 230c. The susceptors 230a, 230b, and 230c may be the same as or similar to the susceptor 230 illustrated in FIG. 4A, and the same descriptions thereof are described on the basis of the susceptor 230 illustrated in FIG. 4A.

An aerosol generating material absorbed by the wick 220 may be heated by the susceptor 230 and atomized into an aerosol. The generated aerosol may flow out of the wick 220 and move to an air flow path (e.g., the air flow path 250 of FIG. 4A).

The generated aerosol may not pass through the susceptor 230. Accordingly, the aerosol may bypass the susceptor 230 and pass through a portion of the wick 220 on which the susceptor 230 is not arranged.

When the susceptor 230 is arranged on an outer surface of the wick 220, the outer surface of the wick 220 may be divided into a first area in which the susceptor 230 is arranged and a second area in which the susceptor 230 is not arranged. In other words, the second area may correspond to the remaining area after excluding the first area on the outer surface of the wick 220.

Hereafter, a part or all of the second area of the wick 220 through which the susceptor 230 is not arranged and thus the aerosol may flow out of the wick 220 may be referred to as a discharge area.

The aerosol may move from the wick 220 to the outside of the wick 220 through a discharge area 225. In particular, the aerosol, which is blocked by the susceptor 230 while moving inside the wick 220, may flow out of the wick 220 through the discharge area 225 around the susceptor 230. Accordingly, the discharge area 225 may refer to an area adjacent to and formed along an edge of the susceptor 230.

Preferably, the edge of the susceptor 230 arranged on the wick 220 may be long in order to secure the large discharge area 225.

For example, when a susceptor having a rectangular plate shape (e.g., the susceptor 230u of FIG. 9) is arranged on the wick 220, the aerosol may not flow out of the first area of the wick 220 in which the susceptor is arranged, and thus, the aerosol inside the wick 220 may be blocked by the susceptor in a relatively large area. In particular, an aerosol atomized on a central portion of the wick 220 needs to move a long distance to the discharge area 225, which is formed on the edge of the susceptor 230u and on a peripheral portion of the wick 220, to flow out of the wick 220.

In contrast, when a plurality of susceptors having a zigzag pattern (e.g., the susceptor 230f of FIG. 9) or a plurality of susceptors having a straight pattern (e.g., the susceptor 230s of FIG. 9) are arranged on the wick 220, the second area may be formed between the first areas. Accordingly, the discharge area 225 may be formed in a relatively large area, and the aerosol may smoothly flow out of the wick 220.

Accordingly, with the same total area of the susceptor 230, the discharge area 225 may be largely formed when the edge of the susceptor 230 is designed to be long.

FIGS. 10A to 10C respectively illustrate the susceptors 230a, 230b, and 230c having various patterns having long edges. When the susceptors 230a, 230b, and 230c having various patterns are arranged on the outer surface of the wick 220, two patterns of the susceptor 230 may be arranged in at least one area of the outer surface of the wick 220.

Here, “two patterns” may refer to two individual susceptors which are not directly/physically connected to each other and are separated from each other in the entire area of an outer surface of a wick, as well as two different portions of the same susceptor, which extend in parallel on the outer surface of the wick. In other words, according to a method of setting one area of an outer surface of a wick, one pattern of a susceptor may appear as a plurality of patterns in the one area.

Here, the discharge area 225 may refer to a space formed between two patterns of the susceptor 230. That is, the discharge area 225 may be formed between different portions of the same susceptor, or between two separate susceptors arranged on the same outer surface of the wick 220.

As the edge of the susceptor 230 increases, the discharge area 225 may be enlarged. As a result, the amount of aerosol flowing out of the wick 220 through the enlarged discharge area 225 may increase. Accordingly, atomization performance may be improved.

FIGS. 10A to 10C illustrate that the aerosol moves in an x-axis direction and a y-axis direction from the edge of the susceptor 230 to flow out of the wick 220, because the aerosol cannot pass through the susceptor 230.

However, the movement direction of the generated aerosol is not limited to the illustrated directions. One of ordinary skilled in the art may easily understand that the aerosol may also move in a z-axis direction and flow out of the wick 220 through the discharge area 225. In addition, one of ordinary skilled in the art may easily understand that the movement of the aerosol generated by the susceptor 230 is illustrated only in a portion of the drawing.

Referring to FIG. 10A, the susceptor 230a may have a spiral pattern. Although FIG. 10A illustrates the susceptor 230a in a rectangular spiral pattern, the spiral pattern is not limited to the embodiment illustrated in FIG. 10A.

For ease of a manufacturing process of a susceptor and reliable atomization performance between adjacent patterns, a distance id between two patterns of the susceptor 230a may be uniform. Here, a distance between two patterns may refer to distance between two adjacent edges (i.e., two adjacent portions) of one or more susceptors, when the edges extend in parallel. The distance may be used in the same meaning below. In addition, hereinafter, a distance of the susceptor may be used in the same meaning as the distance between the two patterns.

Referring to FIG. 10B, the susceptor 230b may include a plurality of first patterns 231 sequentially arranged in one direction (e.g., in a y-axis direction) and a plurality of second patterns 232 connecting the plurality of first patterns 231 in the one direction.

Here, the connection may include both a direct connection in the form of a pattern of a susceptor and an indirect connection such as heating conduction by an electromagnetic field. For the direct connection, the second pattern 232 may include various patterns that connects the first patterns in the one direction, such as bent or curved patterns, as well as straight patterns illustrated in FIG. 10B.

The first pattern 231 may include one or more first extension patterns 231 extending in a direction (e.g., the x-axis direction) crossing the above-mentioned one direction, one or more second extension patterns 2312 extending in the one direction (e.g., the y-axis direction), and a connection pattern 2313 connecting the first extension patterns 231 and the second extension patterns 2312. One or more connection patterns 2313 may be arranged according to the number of first extension patterns 2311 and second extension patterns 2312, and may include various patterns such as bent or curved patterns.

The distance id between two patterns of the susceptor 230b may be uniform.

In detail, as illustrated in FIG. 10B, the distance id between two first extension patterns 2311 included in the same first pattern 231 may be uniform along a direction (e.g., the x-axis direction) in which the two first extension patterns 2311 extend. In addition, a distance between two adjacent first extension patterns 231 of different first patterns 231 may be the same as the distance id described above.

Referring to FIG. 10C, the susceptor 230c may have a pattern similar to the patterns of the susceptor 230b illustrated in FIG. 10B, which are sequentially arranged in one direction (e.g., the y-axis direction). The susceptor 230c may include a plurality of first patterns 231c sequentially arranged in the one direction (e.g., the y-axis direction) and a plurality of second patterns 232c connecting the plurality of first patterns 231c in the one direction (e.g., the y-axis direction).

The second pattern 232c illustrated in FIG. 10C is illustrated in a curved pattern, unlike the straight pattern illustrated in FIG. 10B. However, the second pattern 232c is not limited to the embodiment and may include various patterns.

The first pattern 231c illustrated in FIG. 10C may include two or more first extension patterns 2311 extending in a direction (e.g., the x-axis direction) crossing the above-mentioned one direction, and a connection pattern 2313c connecting two first extension patterns 2311.

The connection pattern 2313c illustrated in FIG. 10C is illustrated in a curved pattern, unlike the bent pattern illustrated in FIG. 10B. However, the connection pattern 2313c is not limited to the embodiment and may include various patterns.

In a bent pattern, heat may be concentrated in a bent portion. When the second pattern 232c and the connection pattern 2313c are arranged in curved patterns, concentration of heat on a portion of the pattern may be alleviated, and the heat may be uniformly distributed in the entire area of the pattern.

Like the susceptor 230b illustrated in FIG. 10B, a distance id between two patterns of the susceptor 230c may be uniform, and may be the same throughout the susceptor 230c.

Referring to FIGS. 10A to 10C, a first area, which is an area occupied by the susceptor 230 in one surface from among the outer surface of the wick 220, may be formed at a location spaced apart by the same distance from an edge of the one surface from among the outer surface of the wick 220, and may occupy 80% or less of the one surface. For example, the first area may occupy 70% to 80% of one surface from among the outer surface of the wick 220.

By arranging the susceptor 230 so that the first area occupies 70% to 80% of the one surface at a location spaced apart by the same distance from the edge of the one surface from among the outer surface of the wick 220, a sufficient space may be secured for an aerosol generating material to move from a storage unit (e.g., the storage unit 210 of FIG. 4A) to the wick 220.

In other words, the wick 220 may effectively absorb the aerosol generating material supplied from the storage unit. Accordingly, a leakage of the aerosol generating material from the storage unit may be alleviated.

Hereinafter, an example in which a distance between two patterns of a susceptor is not uniform is described below with reference to FIGS. 11A and 11B.

FIGS. 11A and 11B are top views of a wick on which a susceptor with unevenly spaced apart patterns is arranged, according to embodiments.

Referring to FIGS. 11A and 11B, a cartridge 20 may include a wick 220 and susceptors 230a and 230b. The susceptors 230a and 230b may be the same as or similar to the susceptor 230 illustrated in FIG. 4A, and the same descriptions thereof are given on the basis of the susceptor 230 illustrated in FIG. 4A.

Unlike the susceptors 230a and 230b illustrated in FIGS. 10A and 10B, a distance (e.g., id of FIGS. 10A and 10B) between two patterns of the susceptors 230a and 230b illustrated in FIGS. 11A and 11B may vary according to a location of the susceptor 230.

Referring to FIGS. 11A and 11B, the susceptors 230a and 230b may include first portions 2301 arranged at a first distance id1 (i.e., a distance between two adjacent patterns is d1) on a peripheral portion 220p of the wick 220, and second portions 2302 arranged at a second distance id2 on a central portion 220c of the wick 220.

Here, each of the first distance id1 and the second distance id2 may be used in the same meaning as the distance id between two patterns of the susceptor described in FIGS. 10A to 10C.

The first distance id1 and the second distance id2 may be different from each other. For example, the first distance id1 with respect to the peripheral portion 220p of the wick 220 may be greater than the second distance id2 with respect to the central portion 220c of the wick 220.

The difference between the first distance id1 and the second distance id2 may be described in three aspects—characteristics of an induction heating method, components of a main body arranged around a wick, and an absorption rate of each portion of the wick.

First, due to the characteristics of the induction heating method, a magnetic flux density of magnetic force lines (e.g., the magnetic force lines M of FIG. 8) may be high on a central axis of an induction coil having a spiral plate shape (e.g., the induction coil 110 of FIG. 8). That is, the magnetic flux density may be relatively higher at the central portion 220c of the wick 220 close to the central axis of the induction coil than at the peripheral portion 220p of the wick 220.

Therefore, when the second portion 2302 of the susceptor arranged on the central portion 220c is arranged more densely than the first portion 2301 of the susceptor arranged on the peripheral portion 220p, heating efficiency of the induction heating method may be maximized.

Second, one or more components of the main body (e.g., the main body 10 of FIG. 4A), such as a support element for supporting the wick 220, may be arranged around an edge or both ends of the wick 220 corresponding to the peripheral portion 220p of the wick 220. When heat is transferred to the main body due to an increase in a temperature of the peripheral portion 220p of the wick 220, the main body may be damaged. For example, thermal deformation may occur in the components of the main body.

When the first portions 2301 of the susceptor arranged on the peripheral portion 220p are arranged less densely than the second portions 2302 of the susceptor arranged on the central portion 220c, a temperature of the peripheral portion 220p may be lower than a temperature of the central portion 220c of the wick 220.

Accordingly, heat transferred from the peripheral portion 220p to the main body may be reduced, and thus, the main body may be protected from heat generated by the susceptors 230a and 230b.

Lastly, the edge or both ends of the wick 220 corresponding to the peripheral portion 220p may absorb an aerosol generating material supplied from a storage unit (e.g., the storage unit 210 of FIG. 4A). The absorbed aerosol generating material may move from the peripheral portion 220p of the wick 220 to the central portion 220c.

The peripheral portion 220p of the wick 220 may be directly supplied with the aerosol generating material from the storage unit, and thus, an absorption rate of the aerosol generating material may be high at the peripheral portion 220p of the wick 220. The central portion 220c is relatively far from the storage unit, and thus, the absorption rate of the aerosol generating material may be relatively low at the central portion 220c of the wick 220. In other words, the absorption rate of the aerosol generating material and an amount the absorbed aerosol generating material may decrease from the peripheral portion 220p of the wick 220 toward the central portion 220c.

As described above, when the first portions 2301 of the susceptor are arranged less densely than the second portions 2302, the temperature of the peripheral portion 220p may be lower than the temperature of the central portion 220c of the wick 220.

Accordingly, an amount of aerosol, which is atomized by the first portion 2301 of the susceptor, may decrease at the peripheral portion 220p of the wick 220. The aerosol generating material, which is not atomized at the peripheral portion 220p, may move to the central portion 220c of the wick 220 and may be atomized into an aerosol by the second portion 2302 of the susceptor at the central portion 220c. Accordingly, a uniform amount of aerosol may be generated at the peripheral portion 220p and the central portion 220c of the wick 220.

Referring to FIG. 11A, a boundary line between the peripheral portion 220p and the central portion 220c of the wick 220 is illustrated as a rectangle with a dash-single dotted line, which is a 4:1 reduction of an upper surface of the wick 220.

Referring to FIG. 11B, the boundary line between the peripheral portion 220p and the central portion 220 of the wick 220 is shown as dash-double dotted lines dividing a length (i.e., a dimension the y-axis direction) of the upper surface of the wick 220 into three equal parts.

However, a peripheral portion and a central portion of a wick are not limited to the embodiment, and a boundary between the peripheral portion and the central portion may be different. In addition, the boundary between the peripheral portion and the central portion of the wick may not be clear, and in this case, a distance between a pattern and a pattern of a susceptor may gradually or abruptly decrease from the peripheral portion toward the central portion.

Hereinafter, a plurality of susceptors arranged on two surfaces from among an outer surface of the wick 220 are described.

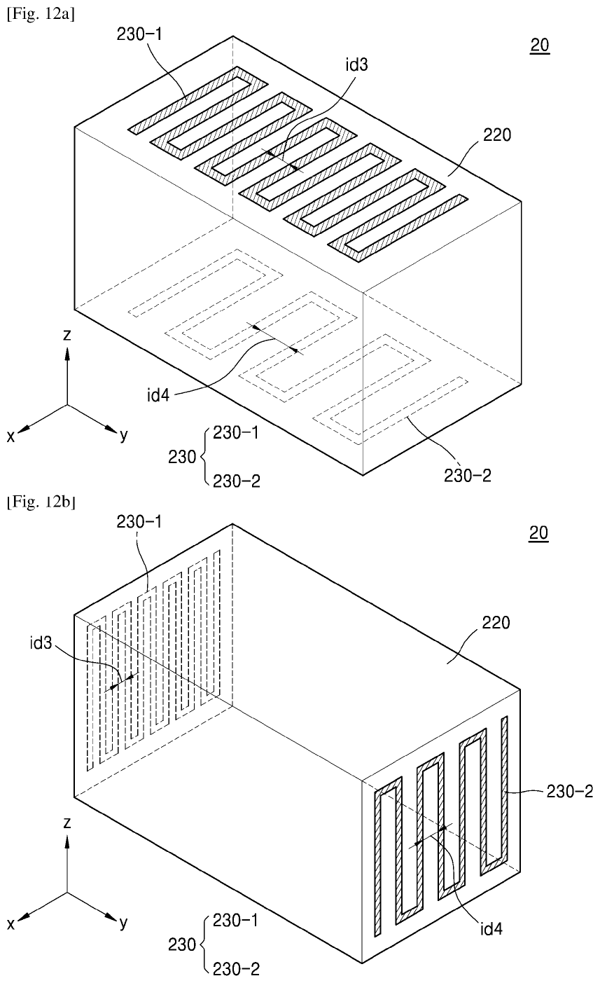

FIGS. 12A and 12B are perspective views of a wick on which two susceptors are arranged on different outer surfaces, according to embodiments.

Referring to FIGS. 12A and 12B, a cartridge 20 may include a wick 220 and a plurality of susceptors 230.

The susceptors 230 may include a first susceptor 230-1 arranged at a third distance id3 on one surface from among an outer surface of the wick 220, and a second susceptor 230-2 arranged at a fourth distance id4 on the other surface of the wick 220 facing the one surface.

Each of the first susceptor 230-1 and the second susceptor 230-2 may be the same as or similar to the susceptor 230 illustrated in FIG. 4A. Each of the third distance id3 and the fourth distance id4 may be used in the same meaning as the distance id between two adjacent patterns of the susceptor described above with reference to FIGS. 10A to 10C.

The third distance id3 and the fourth distance id4 may be different from each other. Hereinafter, it is assumed that the third distance id3 is smaller than the fourth distance id4.

Referring to FIG. 12A, the first susceptor 230-1 may be arranged on an upper surface of the wick 220, and the second susceptor 230-2 may be arrange on a lower surface of the wick 220.

The third distance id3 of the first susceptor 230-1 arranged on the upper surface of the wick 220 may be smaller than the fourth distance id4 of the second susceptor 230-2 arranged on the lower surface of the wick 220, and thus, more heat may be generated at an upper portion of the wick 220 than at a lower portion of the wick 220.

A storage unit (e.g., the storage unit 210 of FIG. 4A) may be arranged on the upper portion of the wick 220, but a main body (e.g., the main body 10 of FIG. 4A) including several electronic components may be arranged on the lower portion of the wick 220. When heat generated at the lower portion of the wick 220 is reduced, the electronic components of the main body adjacent to the lower portion of the wick 220 may be relatively protected.

Accordingly, while atomization performance is maintained by the heat generated at the upper portion of the wick 220, the electronic components arranged on the lower portion of the wick 220 may be protected.

Referring to FIG. 12B, the first susceptor 230-1 may be arranged on a first side surface of the wick 220, and the second susceptor 230-2 may be arranged on a second side surface of the wick 220 opposite to the first side surface.

The third distance id3 of the first susceptor 230-1 arranged on the first side surface may be smaller than the fourth distance id4 of the second susceptor 230-2 arranged on the second side surface, and thus, more heat may be generated on the first side surface than on the second side surface of the wick 220.

As illustrated in FIG. 2, when a cartridge (e.g., the vaporizer 14 of FIG. 2) is arranged asymmetrically with respect to a central axis extending in a longitudinal direction of the aerosol generating device 1, the first side surface of the wick 220, which generates more heat, may be arranged toward the inside of the aerosol generating device 1, and the second side surface of the wick 220, which generates relatively little heat, may be arranged toward the outside of the aerosol generating device 1.

According to an arrangement of a wick described above, heat transferred to an outer surface of an aerosol generating device may be reduced, and thus, high-temperature heat may be prevented from being transferred to the body (e.g., the palm) of a user holding the aerosol generating device.

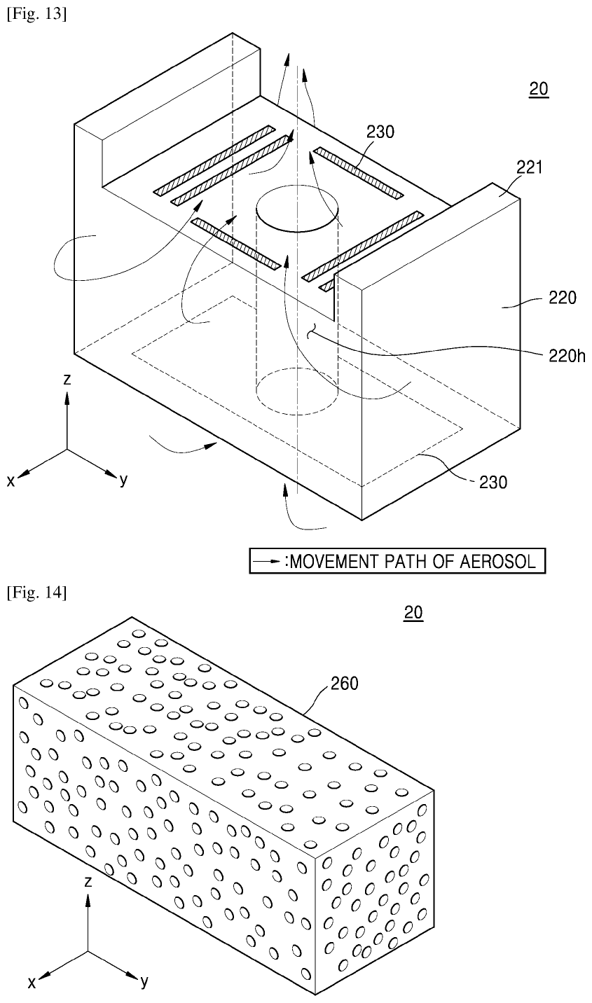

FIG. 13 is a perspective view of a cartridge including a hollow and a joint portion, according to an embodiment.

Referring to FIG. 13, a cartridge 20 according to an embodiment may include a wick 220 and one or more susceptors 230.

At least one of components of the cartridge 20 illustrated in FIG. 13 may be the same as or similar to at least one of the components of the cartridge 20 illustrated in FIG. 9, and the same description thereof is omitted below.

The wick 220 may include a hollow 220h formed to allow an aerosol generated by the susceptors 230 to pass through the wick 220.

Referring to FIG. 13, the hollow 220h may penetrate the wick 220 in a z-axis direction. However, the size, number, and location of the hollow 220h may be variously modified according to embodiments.

If an air flow path (e.g., the air flow path 250 of FIG. 4A) is arranged above the wick 220 and thus an aerosol needs to move in a +z direction, an aerosol generated by the susceptor 230 arranged on a lower surface of the wick 220 may move in the +z direction through the hollow 220h.

Although not illustrated herein, as another example, if the air flow path is arranged under the wick 220, the aerosol needs to move in a −z direction. In this case, an aerosol generated by the susceptor 230 arranged on an upper surface of the wick 220 may move in the-z direction through the hollow 220h.

The wick 220 may include a joint portion 221 protruding toward a storage unit (e.g., the storage unit 210 of FIG. 4A) so that at least a portion of the upper surface of the wick 220 is spaced apart from the storage unit.

The joint portion 221 may be arranged at an edge or end portions of the upper surface of the wick 220 to be in contact with the storage unit such that the remaining portion of the upper surface of the wick 220 at which the joint portion 221 is not arranged is spaced apart from the storage unit. However, an arrangement of a joint portion is not limited to the embodiment.

The joint portion 221 may absorb an aerosol generating material supplied from the storage unit and transfer the aerosol generating material to the entire area of the wick 220.

If the air flow path (e.g., the airflow path 250 of FIG. 4A) is arranged above the wick 220 and thus an aerosol needs to move in the +z direction, an aerosol generated by the susceptor 230 arranged on the upper surface of the wick 220 may flow through a space formed by the joint portion 221. In addition, an aerosol generated by a susceptor (not shown) arranged on a side surface of the wick 220 may move to the space formed by the joint portion 221.

Aerosols, which are collected in the space formed by the joint unit portion 221, may move toward the air flow path.

FIG. 14 is a perspective view illustrating a susceptor integrally formed with a wick, according to an embodiment.

Referring to FIG. 14, a cartridge 20 according to an embodiment may include a susceptor 260 integrally formed with a wick.

The susceptor 260 integrally formed with the wick may absorb an aerosol generating material supplied from a storage unit (e.g., the storage unit 210 of FIG. 4A) and atomize, into an aerosol, the absorbed aerosol generating material by generating heat in response to an induced magnetic field. In other words, the susceptor 260 integrally formed with the wick may simultaneously perform functions of the wick 220 and the susceptor 230 illustrated in FIG. 9.

Like the wick 220 and the susceptor 230 illustrated in FIG. 4A, the susceptor 260 integrally formed with the wick may be arranged under a storage unit of a cartridge. When the cartridge and a main body (e.g., the main body 10 of FIG. 4A) are coupled to each other, the susceptor 260 may be arranged above an induction coil (e.g., the induction coil 110 of FIG. 4A).

The susceptor 260 integrally formed with the wick may include a porous body obtained by sintering metal powder, a mesh body in which metal is arranged in the form of a net (or a mesh), or the like. The susceptor 260 may include a SUS316L. However, the material of the susceptor 260 is not limited thereto, and may include all types of materials capable of simultaneously performing functions of a wick and a susceptor.

The cartridge 20 according to an embodiment may further include a support element (not shown). The support clement may support, inside the cartridge 20, the susceptor 260 integrally formed with the wick. The support element may include all types of materials capable of withstanding heat from the susceptor 260. The arrangement of the support element is not limited to the embodiment, and the support element may be included in the main body.

The susceptor 260 integrally formed with the wick may be a wick and a susceptor at the same time, and thus, aerosols may be generated while heat is generated inside and on all outer surfaces of the susceptor 260. Compared to an embodiment where the wick 220 and the susceptor 230 are individually formed and coupled to each other, when the susceptor 260 is integrally formed with the wick, a heat generation area may increase and ultimately atomization performance may be improved.

When the wick 220 and the susceptor 230 are simply coupled to each other, the wick 220 formed of cotton or silica may be carbonized, and as a result, a harmful material may be generated. When a wick including ceramic is used, the degree of carbonization of the wick may be reduced. However, ceramic powder may be generated from the ceramic wick. The harmful material, such as ceramic powder or the like, may be mixed with aerosols and introduced into the mouth of a user.

In contrast, the susceptor 260 integrally formed with the wick may not be carbonized by heating, and thus may not generate a harmful material. Accordingly, the cartridge 20 including the susceptor 260 integrally formed with the wick may reduce the harmfulness to the user.

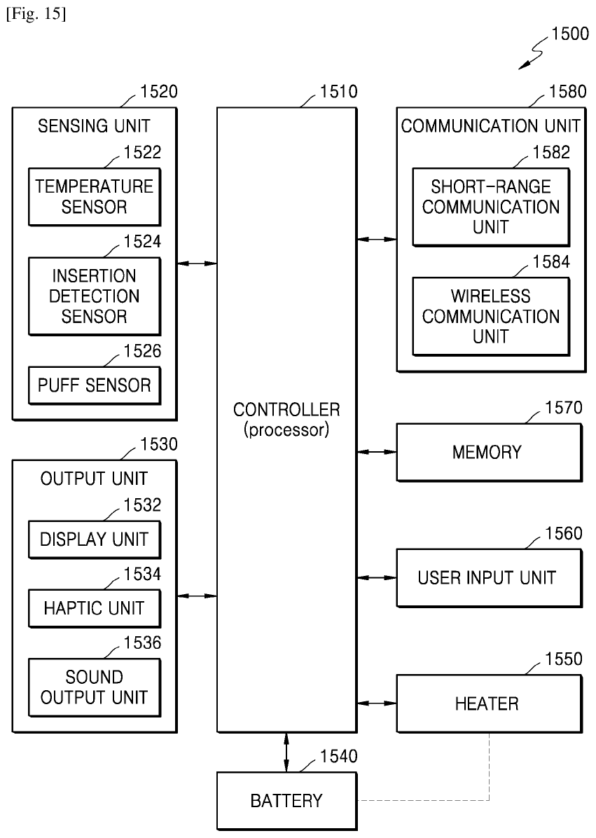

FIG. 15 is a block diagram of an aerosol generating device 1500 according to another embodiment.

The aerosol generating device 1500 may include a controller 1510, a sensing unit 1520, an output unit 1530, a battery 1540, a heater 1550, a user input unit 1560, a memory 1570, and a communication unit 1580. However, the internal structure of the aerosol generating device 1500 is not limited to those illustrated in FIG. 15. In other words, according to the design of the aerosol generating device 1500, it will be understood by one of ordinary skill in the art that some of the components shown in FIG. 15 may be omitted or new components may be added.

The sensing unit 1520 may sense a state of the aerosol generating device 1500 and a state around the aerosol generating device 1500, and transmit sensed information to the controller 1510. Based on the sensed information, the controller 1510 may control the aerosol generating device 1500 to perform various functions, such as controlling an operation of the heater 1550, limiting smoking, determining whether an aerosol generating article (e.g., a cigarette, a cartridge, or the like) is inserted, displaying a notification, or the like.

The sensing unit 1520 may include at least one of a temperature sensor 1522, an insertion detection sensor, and a puff sensor 1526, but is not limited thereto.

The temperature sensor 1522 may sense a temperature at which the heater 1550 (or an aerosol generating material) is heated. The aerosol generating device 1500 may include a separate temperature sensor for sensing the temperature of the heater 1550, or the heater 1550 may serve as a temperature sensor. Alternatively, the temperature sensor 1522 may also be arranged around the battery 1540 to monitor the temperature of the battery 1540.

The insertion detection sensor 1524 may sense insertion and/or removal of an aerosol generating article. For example, the insertion detection sensor 1524 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1526 may sense a user's puff on the basis of various physical changes in an airflow passage or an airflow channel. For example, the puff sensor 1526 may sense a user's puff on the basis of any one of a temperature change, a flow change, a voltage change, and a pressure change.

The sensing unit 1520 may include, in addition to the temperature sensor 1522, the insertion detection sensor 1524, and the puff sensor 1526 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1530 may output information on a state of the aerosol generating device 1500 and provide the information to a user. The output unit 1530 may include at least one of a display unit 1532, a haptic unit 1534, and a sound output unit 1536, but is not limited thereto. When the display unit 1532 and a touch pad form a layered structure to form a touch screen, the display unit 1532 may also be used as an input device in addition to an output device.

The display unit 1532 may visually provide information about the aerosol generating device 1500 to the user. For example, information about the aerosol generating device 1500 may mean various pieces of information, such as a charging/discharging state of the battery 1540 of the aerosol generating device 1500, a preheating state of the heater 1550, an insertion/removal state of an aerosol generating article, or a state in which the use of the aerosol generating device 1500 is restricted (e.g., sensing of an abnormal object), or the like, and the display unit 1532 may output the information to the outside. The display unit 1532 may be, for example, a liquid crystal display panel (LCD), an organic light-emitting diode (OLED) display panel, or the like. In addition, the display unit 1532 may be in the form of a light-emitting diode (LED) light-emitting device.

The haptic unit 1534 may tactilely provide information about the aerosol generating device 1500 to the user by converting an electrical signal into a mechanical stimulus or an electrical stimulus. For example, the haptic unit 1534 may include a motor, a piezo-electric element, or an electrical stimulation device.

The sound output unit 1536 may audibly provide information about the aerosol generating device 1500 to the user. For example, the sound output unit 1536 may convert an electrical signal into a sound signal and output the same to the outside.

The battery 1540 may supply power used to operate the aerosol generating device 1500. The battery 1540 may supply power such that the heater 1550 may be heated. In addition, the battery 1540 may supply power required for operations of other components (e.g., the sensing unit 1520, the output unit 1530, the user input unit 1560, the memory 1570, and the communication unit 1580) in the aerosol generating device 1500. The battery 1540 may be a rechargeable battery or a disposable battery. For example, the battery 1540 may be a lithium polymer (LiPoly) battery, but is not limited thereto.

The heater 1550 may receive power from the battery 1540 to heat an aerosol generating material. Although not illustrated in FIG. 15, the aerosol generating device 1500 may further include a power conversion circuit (e.g., a direct current (DC)/DC converter) that converts power of the battery 1540 and supplies the same to the heater 1550. In addition, when the aerosol generating device 1500 generates aerosols in an induction heating method, the aerosol generating device 1500 may further include a DC/alternating current (AC) that converts DC power of the battery 1540 into AC power.

The controller 1510, the sensing unit 1520, the output unit 1530, the user input unit 1560, the memory 1570, and the communication unit 1580 may each receive power from the battery 1540 to perform a function. Although not illustrated in FIG. 15, the aerosol generating device 1500 may further include a power conversion circuit that converts power of the battery 1540 to supply the power to respective components, for example, a low dropout (LDO) circuit, or a voltage regulator circuit.

In an embodiment, the heater 1550 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1550 may be implemented by a metal wire, a metal plate on which an electrically conductive track is arranged, a ceramic heating element, or the like, but is not limited thereto.

In another embodiment, the heater 1550 may be a heater of an induction heating type. For example, the heater 1550 may include a susceptor that heats an aerosol generating material by generating heat through a magnetic field applied by a coil.

The user input unit 1560 may receive information input from the user or may output information to the user. For example, the user input unit 1560 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 15, the aerosol generating device 1500 may further include a connection interface, such as a universal serial bus (USB) interface, and may connect to other external devices through the connection interface, such as the USB interface, to transmit and receive information, or to charge the battery 1540.

The memory 1570 is a hardware component that stores various types of data processed in the aerosol generating device 1500, and may store data processed and data to be processed by the controller 1510. The memory 1570 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1570 may store an operation time of the aerosol generating device 1500, the maximum number of puffs, the current number of puffs, at least one temperature profile, data on a user's smoking pattern, etc.

The communication unit 1580 may include at least one component for communication with another electronic device. For example, the communication unit 1580 may include a short-range wireless communication unit 1582 and a wireless communication unit 1584.

The short-range wireless communication unit 1582 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1584 may include a cellular network communication unit, an Internet communication unit, a computer network (e.g., local area network (LAN) or wide area network (WAN)) communication unit, or the like, but is not limited thereto. The wireless communication unit 1584 may also identify and authenticate the aerosol generating device 1500 within a communication network by using subscriber information (e.g., International Mobile Subscriber Identifier (IMSI)).

The controller 1510 may control general operations of the aerosol generating device 1500. In an embodiment, the controller 1510 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1510 may control the temperature of the heater 1550 by controlling supply of power of the battery 1540 to the heater 1550. For example, the controller 1510 may control power supply by controlling switching of a switching element between the battery 1540 and the heater 1550. In another example, a direct heating circuit may also control power supply to the heater 1550 according to a control command of the controller 1510.

The controller 1510 may analyze a result sensed by the sensing unit 1520 and control subsequent processes to be performed. For example, the controller 1510 may control power supplied to the heater 1550 to start or end an operation of the heater 1550 on the basis of a result sensed by the sensing unit 1520. As another example, the controller 1510 may control, based on a result sensed by the sensing unit 1520, an amount of power supplied to the heater 1550 and the time the power is supplied, such that the heater 1550 may be heated to a certain temperature or maintained at an appropriate temperature.

The controller 1510 may control the output unit 1530 on the basis of a result sensed by the sensing unit 1520. For example, when the number of puffs counted through the puff sensor 1526 reaches a preset number, the controller 1510 may notify the user that the aerosol generating device 1500 will soon be terminated through at least one of the display unit 1532, the haptic unit 1534, and the sound output unit 1536.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A cartridge comprising:
a storage unit configured to store an aerosol generating material;
a wick arranged under the storage unit and configured to absorb the aerosol generating material supplied from the storage unit; and
at least one susceptor arranged on at least one outer surface of the wick, and configured to atomize the aerosol generating material absorbed into the wick into an aerosol by generating heat in response to an induced magnetic field.

2. The cartridge of claim 1, wherein the susceptor is arranged parallel to a direction in which a lower surface of the storage unit extends.

3. The cartridge of claim 1, wherein the at least one susceptor includes a plurality of susceptors arranged on different outer surfaces of the wick.

4. The cartridge of claim 1, wherein the at least one susceptor includes a plurality of susceptors arranged on a same outer surface of the wick.

5. The cartridge of claim 1, wherein the wick includes a first area in which the susceptor is arranged and a second area in which the susceptor is not arranged, and the second area includes a discharge area through which the aerosol exits the wick.

6. The cartridge of claim 5, wherein the discharge area is formed along edges of the susceptor.

7. The cartridge of claim 5, wherein the susceptor includes two patterns arranged on a same outer surface of the wick, and the discharge area is formed between the two patterns.

8. The cartridge of claim 1, wherein the susceptor includes a spiral pattern.

9. The cartridge of claim 1, wherein the susceptor includes a plurality of first patterns sequentially arranged in one direction and a plurality of second patterns connecting the plurality of first patterns in the one direction.

10. The cartridge of claim 9, wherein the first patterns include a first extension pattern extending in a direction crossing the one direction, a second extension pattern extending in the one direction, and a connection pattern connecting the first extension pattern and the second extension pattern.

11. The cartridge of claim 9, wherein the second patterns include a curved pattern.

12. The cartridge of claim 1, wherein the susceptor includes first portions parallel to each other and spaced apart by a first distance on a peripheral portion of one outer surface of the wick, and second portions parallel to each other and spaced apart by a second distance on a central portion of the one outer surface of the wick, and the first distance is greater than the second distance.

13. The cartridge of claim 1, wherein
the susceptor includes a first susceptor arranged on one outer surface of the wick, and a second susceptor arranged on another outer surface of the wick opposite to the one outer surface,
the first susceptor includes first portions parallel to each other and spaced apart by a third distance, and the second susceptor includes second portions spaced apart by a fourth distance, and
the third distance is less than the fourth distance.

14. A cartridge comprising:
a storage unit configured to store an aerosol generating material; and
a susceptor integrally formed with a wick, which is arranged under the storage unit and configured to absorb the aerosol generating material supplied from the storage unit and atomize the absorbed aerosol generating material into an aerosol by generating heat in response to an induced magnetic field.

15. An aerosol generating device comprising:
the cartridge of claim 1; and
a main body including an induction coil arranged under the cartridge to generate the induced magnetic field.
